(19) United States
(12) Patent Application Publication
(10) Pub. No.: US 2006/0022980 A1
(43) Pub. Date: Feb. 2, 2006

(54) Material coded imagery for computer generated forces

(76) Inventors: Kenneth Burton Donovan, Apalachin, FL (US); Michael J. Longtin, Orlando, FL (US)

Correspondence Address: WELSH & KATZ, LTD, 120 S RIVERSIDE PLAZA, 22ND FLOOR, CHICAGO, IL, 60606, US

(21) Appl. No.: 10/900,646

(22) Filed: Jul. 28, 2004

(51) Int. Cl. G06T 17/00

(52) U.S. Cl. 345/428

(57) ABSTRACT

Systems and methods usable to provide synthetic environments for computer generated forces include supplemental surface material identifying information applicable to the respective surface. Polygons used to represent the surface can be overlayed with supplemental surface material information to provide a higher fidelity environment in which to mobilize the computer generated forces.

### FIELD OF THE INVENTION

The invention pertains to systems and methods for the generation of synthetic environments for training or mission rehearsal. More particularly, the invention pertains to systems and methods to increase speed of creation and accuracy of landscapes for virtual battlefields which might be traversed by computer generated forces.

### BACKGROUND OF THE INVENTION

There is a continuing and ongoing need to be able to generate authentic synthetic environments in connection with training or exercise rehearsal. For example, aircraft or vehicular simulators provide more realistic simulations and enhance the training and/or rehearsal experiences of the participants by using dynamically changing, real time, out the window displays or scenes. Particularly in connection with aircraft, these displays can represent large areas of terrain which can be viewed, preferably in real time, by the participant. Such displays require large databases derived from, for example, satellite images, high altitude photography or the like.

The databases and display equipment must be able to take into account widely changing scenes relative to a common area which could include take offs or landings, as well as high or low altitude engagements with simulated adversaries. One such approach has been disclosed and claimed in published U.S. patent application 2004/0075667 A1, assigned to the Assignee hereof and entitled System and Related Methods for Synthesizing Color Imagery, incorporated by reference herein.

Realistic simulation experiences will likely include computer generated forces (CGF) which move across the displayed terrain and exhibit behavior consistent with terrain features such as water, trees, buildings and the like. Typical forces could include tanks, self-propelled artillery, boats, as well as mechanized or dismounted infantry.

Terrain databases for modeling and simulation are known and commercially available. Commercially available software can be used to process such databases and, for example, extract features or the like. In addition commercially available software can be used to create and automate both friendly and enemy forces.

Another prior art system 10 is disclosed in FIG. 1. In the system of FIG. 1, the desired real world surface representation is initially provided by database 12, the corrected imagery/raster map of the region of interest. This imagery could, for example, be an overhead view of the geographical area of interest.

The database 12 is processed to produce a full feature set 14. It is recognized that production of the full feature set 14 is both time consuming and is a source of errors, miscorrelations and loss of fidelity.

As is known, the corrected imagery/raster map 12 could be processed to produce out the window image tiling 16 to at least in part produce visual displays for the simulation participants.

The full feature set 14 can in turn be combined with a terrain grid 18, and a model library 20, to produce terrain triangulation and feature placement information 22. The out the window image tiling 16 and the terrain triangulation and feature placement 22 are stored in visual/infrared database 26. Additional databases such as radar database 28 and semi-automated forces (SAF) or CGF database 30 can also be loaded with the terrain triangulation and feature placement information 22.

The full feature set 14 typically would incorporate a plurality of polygons to represent the respective geometric surfaces. Each polygon would be assigned a single surface type of material. At times, such polygons may cover a large area which could include a plurality of materials. As a result, the limit of a single material per polygon reduces the fidelity of the surface material presentation during the simulation or training exercise. The limitation is particularly evident in systems which include other presentations of a plurality of materials in the area. This would be evident if the area is visualized using overhead image resources.

As noted above, the process of extracting the full feature set 14 from the corrected imagery/raster map database 12 requires extensive time and effort. A significant portion of this time and effort is devoted to obtaining the surface material definition for the various polygons. For example, manual digitalization of material outlines from maps or from overhead imagery is often required to provide polygon material definition or assignments.

There continues to be an ongoing need to produce synthetic or simulated environments and databases for CGF more rapidly than has heretofore been possible. Additionally, it would be desirable to be able to minimize the errors and loss of fidelity that is often associated with the process of developing full feature sets, such as set 14.

### BRIEF DESCRIPTION OF THE DRAWINGS

FIG. 1 is a diagram of a prior art system and process of developing databases for a simulation or training environment;

FIG. 2 is a diagram of a system and method in accordance with the invention;

FIGS. 3A, 3B, 3C taken together, illustrate various processes of establishing material coded imagery from various sources;

FIG. 4 illustrates the results of combining material coded imagery with vector features and producing various synthetic environment databases, including a CGF database;

FIG. 5 is an overall flow diagram of a process in accordance with the present invention;

FIG. 6 is a flow diagram of a process for associating material coded image information with various pixels; and

FIG. 7 illustrates an exemplary process of overlaying respective polygons with information associated with respective pixels.

### DETAILED DESCRIPTION OF THE EMBODIMENTS

While embodiments of this invention can take many different forms, specific embodiments thereof are shown in the drawings and will be described herein in detail with the understanding that the present disclosure is to be considered as an exemplification of the principles of the invention, and as a disclosure of the best mode of practicing the invention. It is not intended to limit the invention to the specific embodiment illustrated.

Systems and methods for creating databases with material coded imagery for computer generated forces in accordance with the invention can shorten preparation time thereby incorporating more flexibility into the training process. Missions can be simulated sooner and with greater realism than with prior art systems.

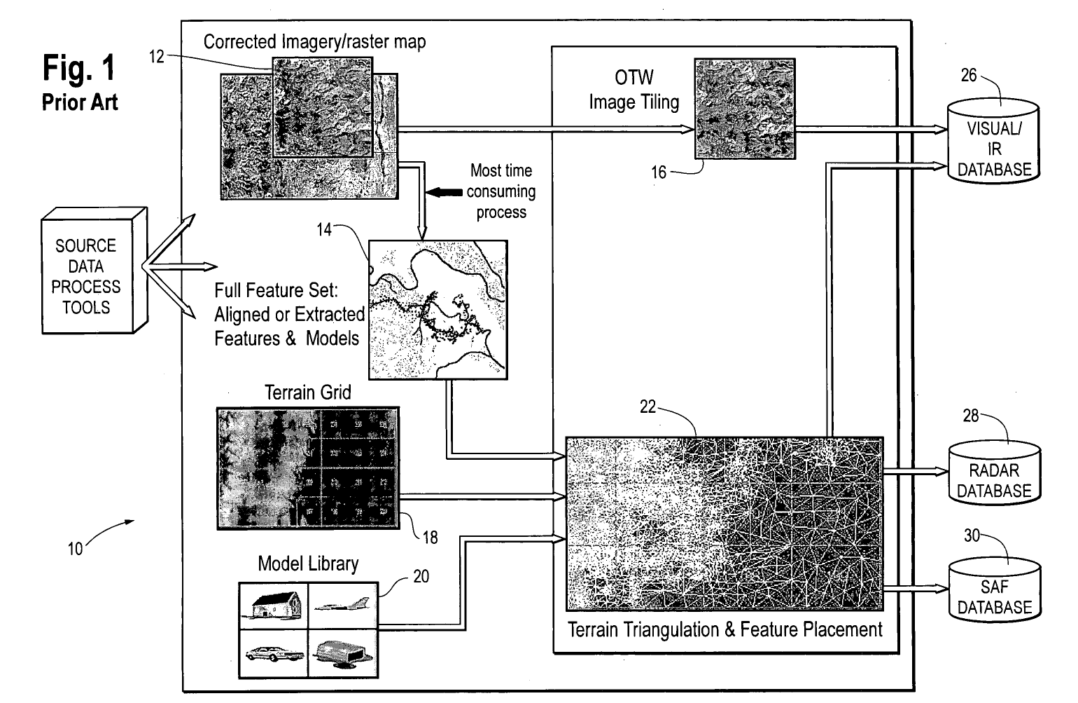

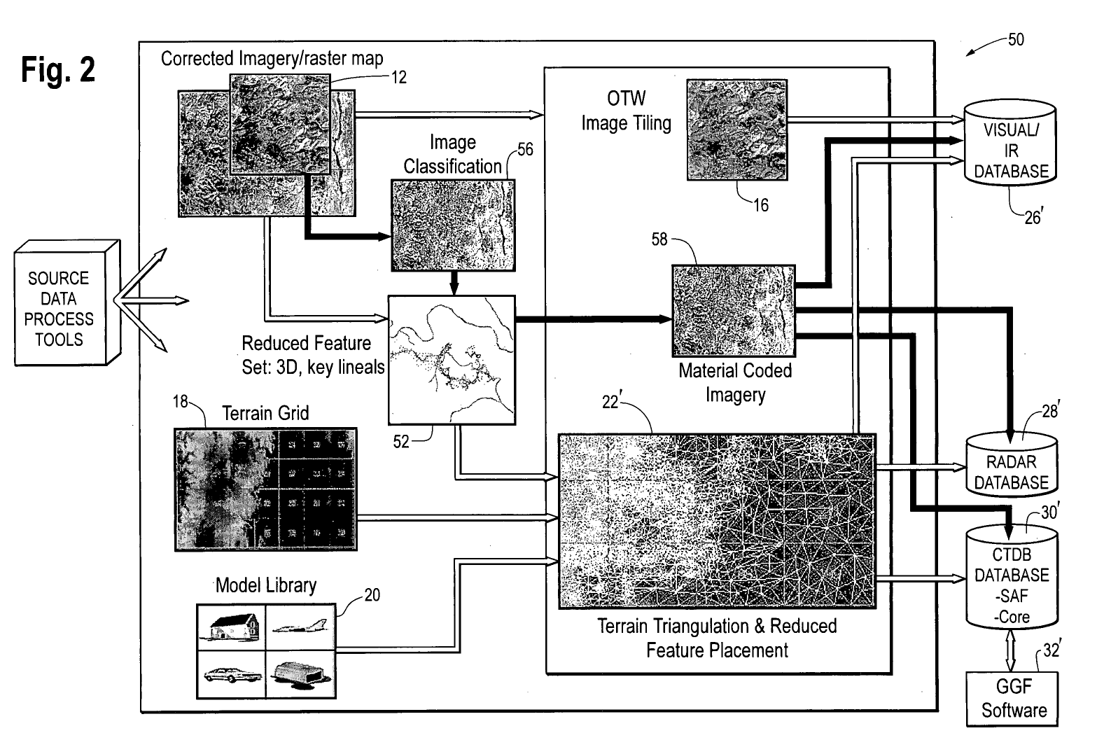

FIG. 2 illustrates a system and process 50 in accordance with the present invention. Those elements of FIG. 2 which correspond to previously discussed elements of FIG. 1 have been assigned the same identification numerals.

Item image classification software 56 of a known type can process data from the corrected image/raster map 12 to form pixel based material coded imagery data 58. For example, each pixel could represent geographical area such as 5 meters square of the region of interest. The pixel based material coded imagery data includes type of surface material present at some or all of the respective pixel.

The corrected image/raster map 12 is processed, using commercially available software, to produce a reduced feature set 52 which can be represented using a plurality of polygons as would be understood by those of skill in the art. The reduced feature set illustrates three dimensional aspects of the terrain of interest along with key lineals; points or other features that are not adequately represented in the material coded imagery. The reduced feature set is generally much smaller than the full feature set, and can even be an empty set, so it can be created more quickly than the full feature set. The reduced feature set 52 is combined with terrain grid 18 and model library 20 to form terrain triangulation and reduced feature placement data 22′.

Each pixel is assigned a data value which represents the material for that particular geographical area. For example, and without limitation, indicia and types of material could include:

| | |
|---|---|
| 0 | corresponds to a null entry |
| 1 | corresponds to water |
| 2 | corresponds to sand |
| 3 | corresponds to trees |
| 4 | corresponds to grass |
| 5 | corresponds to concrete |
| 6 | corresponds to dirt |

Additionally, each pixel material can be assigned a height, as discussed in Donovan U.S. Pat. No. 4,780,084 for a radar simulator and incorporated by reference herein. In such an instance, the material height for a pixel can be used to modify the underlying elevation for the pixel, increasing fidelity. For example, a pixel with “tree” material may be assign an elevation (e.g. 10 meters), indicating that the pixel is higher than the underlaying surface.

The material coded imagery pixels 58 include a geographical position header to identify the location of the respective pixel in the subject environment. For example, each pixel could be identified with either Cartesian or geodesic coordinates. Different resolutions can be provided for different pixels.

More than on type of material can be identified per pixel. In such an instance, pixel data can incorporate multiple codes reflecting multiple types of surfaces present in respective portions of the pixel.

Those of skill will understand that the information from the respective pixels 58 will be layered on terrain surface data 22′. Surface data 22′, for example polygons, can exhibit lineals, areas and default material attributes. Conflicts need to be addressed. Lineals, roads for example, will usually take precedence over MCI data 58. If no MCI data is present for respective coordinates, the default terrain material will be used.

Prioritization can be provided to resolve areas where multiple objects are defined for the same area with different materials. For example, a material coded pixel might be coded for a selected material. On the other hand, three dimensional objects, areals might be present at the corresponding coordinates 22′. In such instances, one form of prioritization can correspond to:

1. Where there is a conflict between material coded imagery 58 and 3D objects, lineals or areals at a respective coordinate or region, lineals, are always assigned a higher priority than the respective material coded imagery 58. Conflicts can be resolved with areals using the following exemplary priority process:

1. MCI priority designation of “true” indicates that the MCI data take priority over the current areal material.

2. MCI priority designation of “false” indicates that the current areal material takes priority over the MCI coded material.

3. MCI priority designation of “available” indicates that MCI data is available for at least part of the respective polygon.

It will be understood that databases 26′, 28′ can be used with various simulation programs to present displays for participants (such as visual, IR or radar). Database 30′ can be used by CGF mobilizing software 32 to provide more realistic force behavior. These databases incorporate respectively, at least material coded imagery 58, and the reduced feature placement data correlated to the triangulated terrain 22′ for purposes of presenting an appropriate display as well as providing enhanced terrain information for CGF.

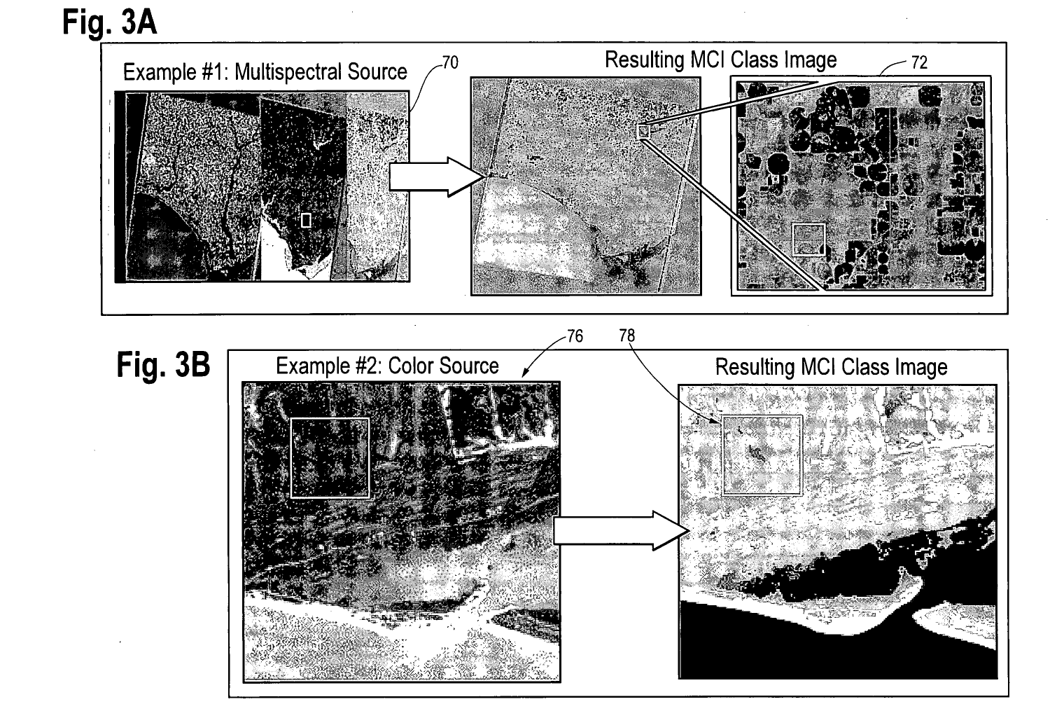

The image classification software can process various types of source data to produce the material coded imagery data 58. FIGS. 3A and 3B illustrate two different sources of data from which the image classification software 56 can produce the material coded imagery data 58. For example, in FIG. 3A, data from a multi-spectral source 70 can be processed by the image classification software 56 to produce material coded imagery data, on a per pixel basis, 72. Similarly, as illustrated in FIG. 3B, color source data 76 can be processed using image classification software 56 to produce pixels, such as pixel 78 of material coded imagery 58.

FIG. 3C illustrates material coded imagery 58 derived from an image 80-1, and correlated with a vector representation, such as representation 80-2. Image 82 illustrates different material classes associated with respective regions of geography 80 in response to processing by image classification software 56.

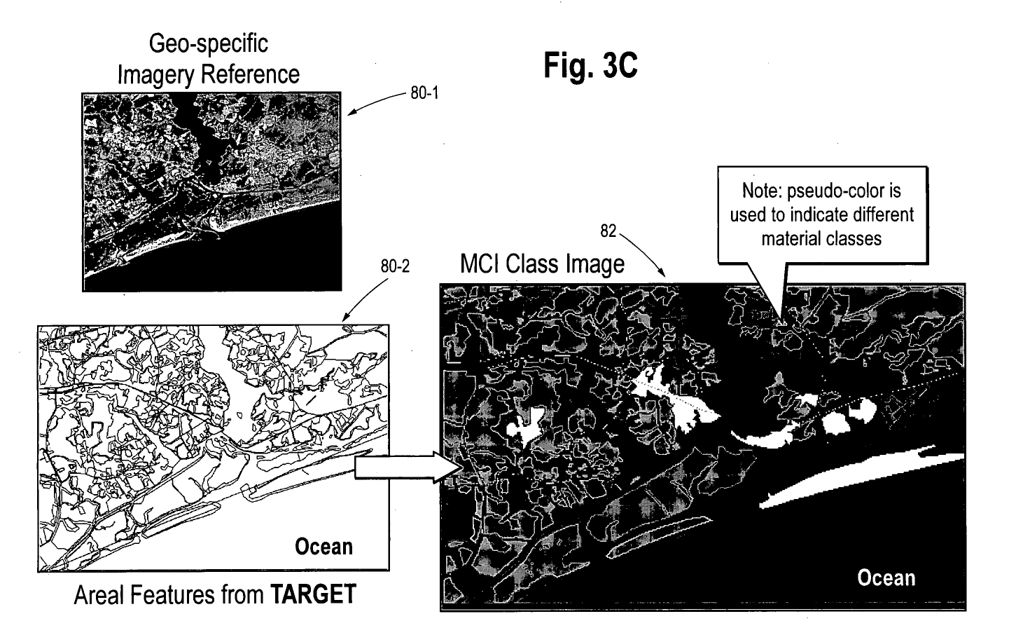

FIG. 4 illustrates exemplary run-time results relative to each of the databases 26′, 28′ and 30′ using the material coded imagery data 58′. In exemplary FIG. 4, the MCI surface information has been obtain from multi-band imagery 70′ to produce pixelized representations with surface indicia 58′.

Correlated run time information associated with respective databases 26′, 28′ and 30′ is illustrated by colorized out the window visual displays and thermal images 26′-1, -2, the respective radar image correlated with vector information from the reduced feature set 52 is illustrated in image 28′-1. Finally, trafficability information usable by the computer generated, or, semi-automated forces, database 30′, is illustrated by display 30′-1.

Database 30′ thus reflects both material coded imagery data 58 as well as the reduced feature set polygonal-type representation 22′. As would be understood by those of skill in the art, the computer generated forces would behave more realistically during a simulation or training exercise than would be the case without the additional material coded data.

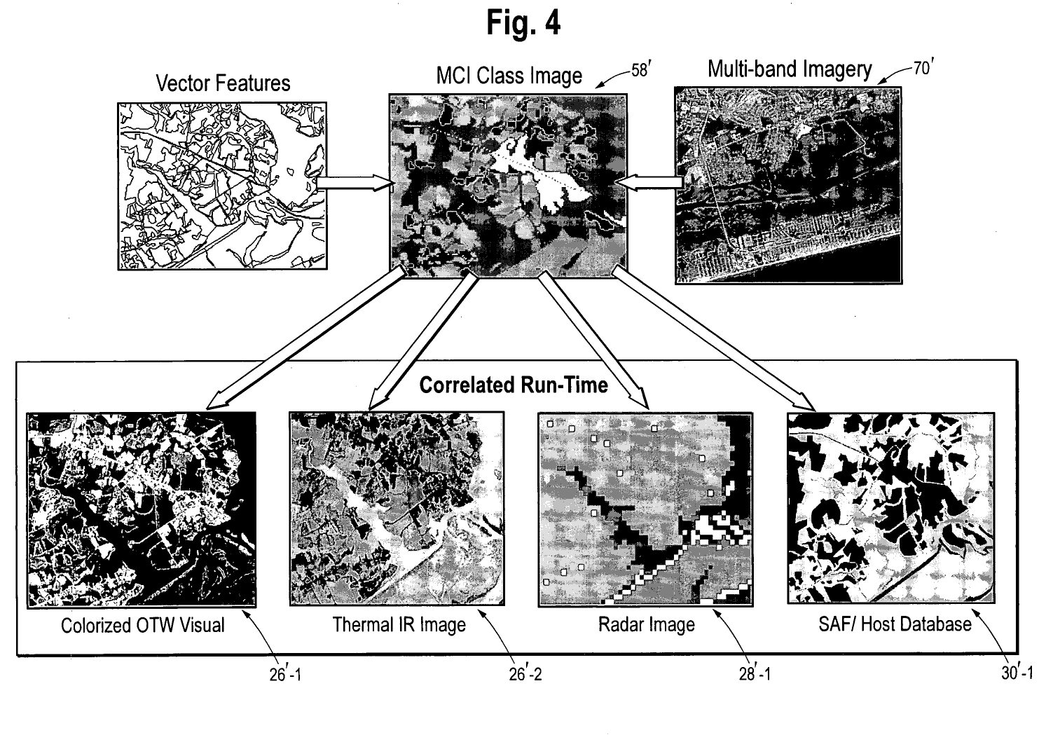

FIG. 5 illustrates additional details of a method 100 in accordance with the invention. In step 102, a particular geographical database, such as the database 12 is selected. In step 104, the material coded imagery information is generated from selected inputs. The reduced feature set of at least part of that database is then created, step 106.

The reduced feature set, such as reduced feature set 52, is combined with terrain grid 18 and model library 20, step 110. The material coded imagery information, such as information 58 can then be stored along with the combined reduced feature set information, terrain grid and library information in respective databases such as 26′, 28′ and 30′, step 112. The stored material coded data and terrain data can be used at simulation run-time, step 114 to improve realism of mobility of computer generated forces.

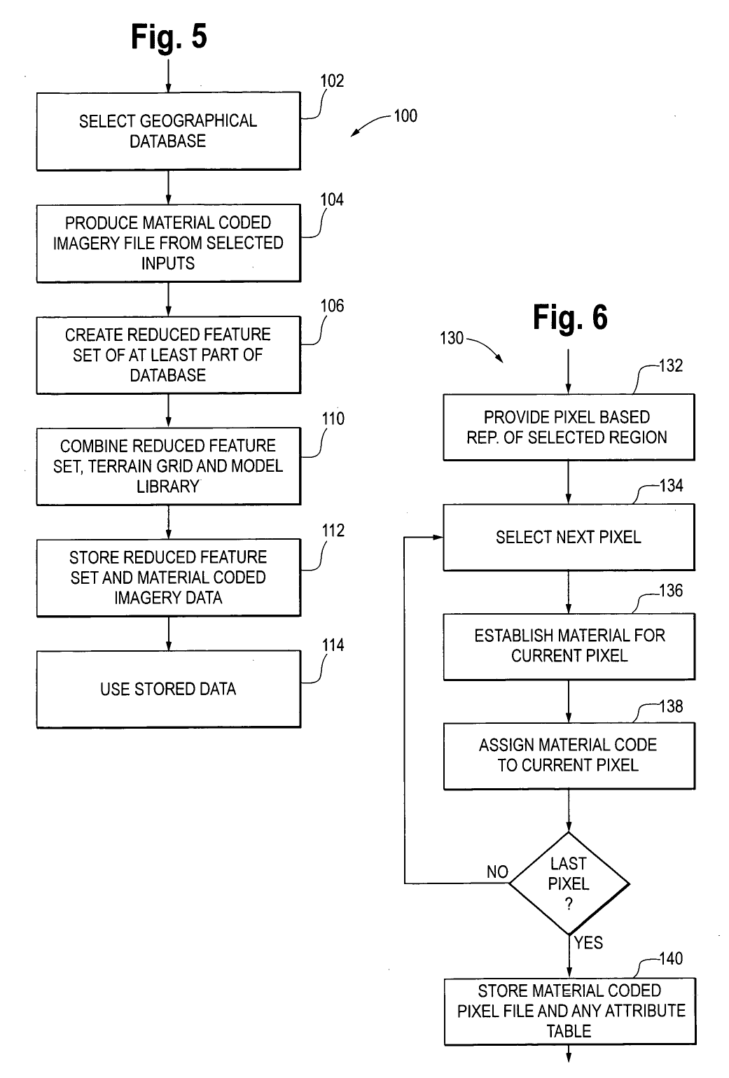

FIG. 6 is an exemplary flow diagram of a process 130 of pixel coding in accordance with the invention. In step 132 a pixel based representation of a selected region is provided. In step 134, the next pixel to be processed is selected.

The material for the current pixel is established, step 136. In step 138 a surface material code is established for the current pixel. If the last pixel has been processed, the material coded pixel data and associated attribute table can be stored in a respective database, step 140. Otherwise, the process returns to step 134 to process the next pixel.

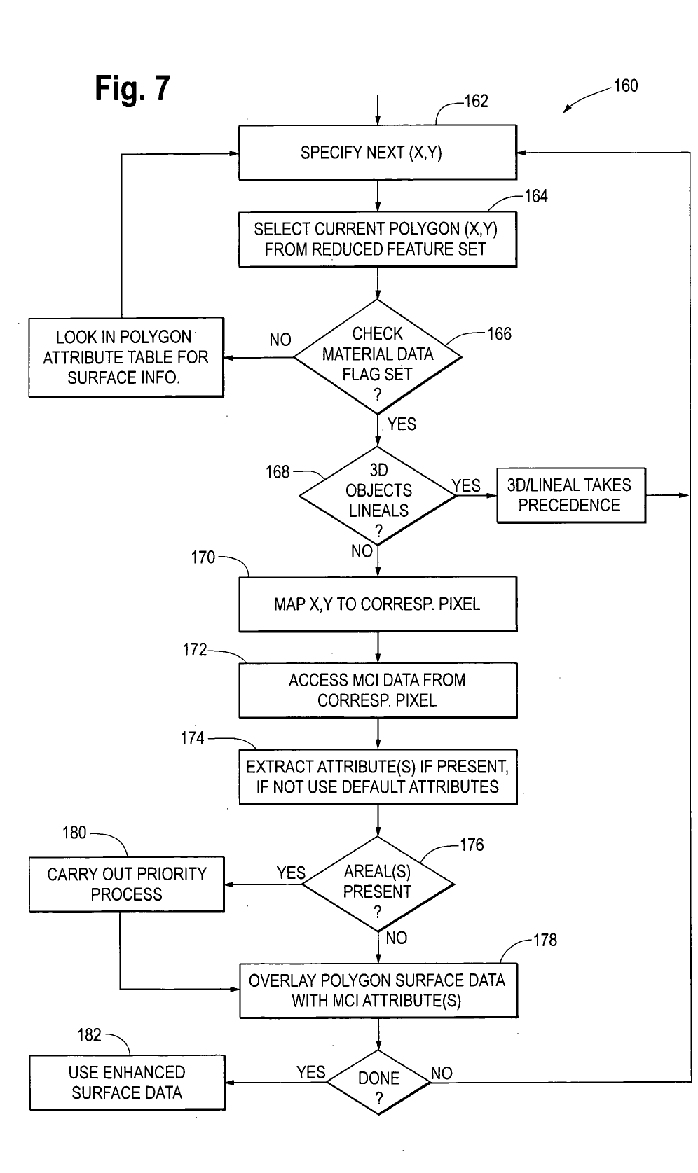

FIG. 7 illustrates yet another exemplary process 160 in accordance with the invention. In the process 160, the material coded data is associated with respective polygons of the reduced feature placement data 22′ which might be stored in a database, such as database 30′.

In a step 162, the next Cartesian coordinate is specified. The respective polygon corresponding to that pair of coordinates is then selected, step 164.

In step 166 a check is made to determine if the material data flag of the respective polygon has been set. If yes, in step 168 an evaluation is carried out to determine if lineals are present. If so, they take priority over any MCI data. If not, the respective coordinates X, Y are mapped to the respective pixel of the material coded imagery 58, step 170. Those of skill in the art will understand that processes are known and available for establishing a correlation between Cartesian coordinates of a region X, Y and the geodedic coordinates of various pixels. One such system has been disclosed in Donovan et al. U.S. Pat. No. 5,751,62 entitled “System and Method for Accurate and Efficient Geodetic Database Retrieval” assigned to the Assignee hereof, and incorporated by reference herein.

In step 172, the respective pixel data is accessed. In step 174 the respective material coded data is extracted for the respective pixel. In step 176 a determination is made if priority needs to be established between a local areal(s) and the respective MCI data. If not, then in step 178, that respective MCI surface information is associated with the respective polygon. Otherwise the prioritizing process, discussed above is carried out, step 180. Then the appropriate material data is associated with the subject polygon, step 178. If finished, the composite polygon information, including the overlayed coded imagery information can be subsequently retrieved and displayed or used in the operation of computer generated forces, step 182. It will be understood that variations in the above processes can be implemented and come within the spirit and scope of the invention.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A simulation method comprising:
providing an environmental image related database;
establishing a set of coordinates in the database;
determining if pre-established surface material related imaging information is available at the established coordinates;
in response to available material related information, incorporating that information into the imagery associated with the set of coordinates; and
using the incorporated information in connection with implementing the behavior of computer generated forces.

2. A method as in claim 1 which includes resolving conflicts between potential images for a selected region.

3. A method as in claim 1 which includes establishing a reduced feature set from the database, and, incorporating material related image information into at least regions of the reduced feature set.

4. A method as in claim 3 which includes overlaying a material type on a portion of the reduced feature set as defined by the available material related information.

5. A method as in claim 4 which includes determining coordinates of the surface material related imaging information that correspond to the established coordinates.

6. A method as in claim 1 which includes establishing a material coded imagery file which incorporates the surface material related imaging information.

7. A method as in claim 6 where said surface material related imaging information includes a plurality of material heights corresponding to different surface feature elevations.

8. A method as in claim 3 which includes establishing a terrain file which incorporates reduced feature set information.

9. A method as in claim 8 where said reduced feature set information represents features that are not evident in the material coded imagery.

10. A method as in claim 6 where the material coded imagery file incorporates indicia corresponding to a plurality of different surface materials.

11. A method as in claim 6 where the surface materials comprise at least one of sand, earth, water, trees, grass or concrete.

12. A system comprising:
a digital representation of a region;
first software that processes the representation to produce coded pixels associated with at least portions of the representation;
a database of information defining a region;
additional software to incorporate information associated with at least some of the coded pixels into the database for use in defining behavior of computer generated forces.

13. A system as in claim 12 which includes feature software producing a reduced feature set in part useable to create the database.

14. A system as in claim 13 where the first software is coupled to the feature software.

15. A system as in claim 14 with the feature software also produces a reduced feature terrain representation from a selected digital representation of the region.

16. A system as in claim 15 where the reduced feature terrain representation is combined with information from at least some of the coded pixels and stored in a common database.

17. A system as in claim 16 which includes software which retrieves information from the common database for visual presentation of enhanced terrain imagery.

18. A system comprising:
a database with a geographical representation of a selected landscape;
a stored reduced feature representation of at least part of the landscape;
a stored pixel based representation of at least part of the landscape which is coded to respresent surface material present in respective pixels; and
software for enhancing the reduced feature representation with coded surface material information from the pixel based representation.

19. A system as in claim 18 which includes additional software for using the enhanced feature representation in mobilizing computer generated forces.

20. A system as in claim 18 where the software for enhancing includes software for associating coded types of material with respective coordinates of the reduced feature representation.

21. A system as in claim 18 where the software for enhancing includes additional software to determine if a coded material representation is available for use at a selected location of the reduced feature presentation.

22. A system as in claim 21 where the additional software, responsive to the determination, associates at least one material identifying indicium with the selected location.

23. A system as in claim 22 which includes presentation software for presenting the selected location with the identified material thereon.

24. A system as in claim 22 which includes prioritizing software which selectively blocks usage of the identified material in connection with the selected location.

25. A system as in claim 22 where the material identifying indicium specifies at least one of water, dirt, concrete, sand, trees or grass.

26. A system as in claim 22 where the material indentifying indicium specifies a material elevation for the corresponding pixel.

27. A system as in claim 22 where the additional software associates a plurality of material identifying indicia with the selected location.

28. A system as in claim 18 where selected pixels of the stored pixel based representation are each coded with a plurality of material indicia.

29. A system as in claim 28 where the software for enhancing includes software for associating a plurality of coded types of material with respective coordinates of the reduced feature representation.

30. A system as in claim 18 which includes additional software for using the enhanced feature representation in at least one of presenting an out the window display, or presenting a radar display.

31. A data structure, storable on a medium, comprising:
pixel based material coded imagery information,
the information specifying at least one type of material associated with at least some of the pixels; and
where each pixel includes identifying coordinates.

32. A data structure as in claim 31 where the information includes material specifiers from a class which includes at least water, sand, dirt, trees, grass and concrete.

33. A data structure as in claim 31 where the identifying coordinates are one of Cartesian coordinates or geodetic coordinates.

34. A data structure as in claim 31 where, relative to at least some pixels, a material elevation is specified for the respective pixel.

35. A system comprising:
a forces database which includes digital terrain information defining, at least in part, a selected geographical area, and separate information specifying types of surface materials present in various sub-regions of the area;
forces software for implementing a computer generated force scenario with forces movable in at least parts of the area; and
additional software coupled to the database and the forces software for extracting selected terrain information and selected material specifying information usable by the forces software in moving at least some of the forces in the area.

36. A system as in claim 35 including a visual database having visual digital terrain information related to the area and information specifying types of surface materials present in various sub-regions of the area.

37. A system as in claim 36 including a radar database having radar digital terrain information related to the area and information specifying types of surface materials present in various sub-regions of the area.

38. A system as in claim 35 which includes software for modifying the separate information whereupon the forces software, responsive thereto, modifies movement of at least some of the forces in the area.

39. A system as in claim 35 where the presence of separate information for a selected sub-region is indicated by an indicium associated with selected coordinates in the selected geographical area.

40. A system as in claim 39 where the separate information comprises a selected file in a forces database.

41. A terrain processing system comprising:
a terrain database;
software for providing a reduced feature version of that database;
software for establishing a plurality of pixel based surface characteristics for at least portions of the terrain;
software for combining elements of the reduced feature version with surface characteristics from corresponding pixels to produce a terrain representation based thereon.

42. A system as in claim 41 where the pixel based surface characteristics include a plurality of surface materials for the pixel.

43. A system as in claim 41 where the pixel based surface characteristics include a surface material elevation for the pixel.

44. A system as in claim 41 which includes software for combining movement of a plurality of simulated vehicles across the terrain representation.

45. A system as in claim 44 which includes software for visually presenting the movement of the simulated vehicles across the terrain representation.

46. A system as in claim 41 where the establishing software selects surface characteristics from a class which includes at least, water, concrete, blacktop, grass, sand and trees.

47. A system as in claim 44 where the element combining software includes software for converting pixel related coordinates to coordinates associated with the reduced feature version.

48. A system as in claim 47 which includes software for evaluating a surface characteristic of selected coordinates of the reduced feature version before combining the respective surface characteristics therewith.

49. A system as in claim 48 where the software for evaluating, responsive to the results of the evaluating, selects the surface characteristics of the reduced feature version and not the surface characteristics of the respective pixel.

50. A system as in claim 49 which includes software for visually presenting the movement of the simulated vehicles across the terrain representation.

51. A system for computer generated forces comprising:
terrain indicative data associated with a geographical region;
surface material coded data, the data incorporating at least position indicia and surface material coded indicia associated with respective sub-regions of the geographical region, the coded data available to overlie the respective sub-regions;
the computer generated forces are responsive to the terrain data with the coded material overlay.

52. A system as in claim 51 where the coded material overlay includes surface material elevation information.
